(19) United States
(12) Patent Application Publication
(10) Pub. No.: US 2009/0269121 A1
(43) Pub. Date: Oct. 29, 2009

(54) DISPENSING AND APPLICATOR DEVICES

(75) Inventors: John Snedden, Sandpoint, ID (US); Clinton J. Marshall, Rathdrum, ID (US)

Correspondence Address: SPECKMAN LAW GROUP PLLC, 1201 THIRD AVENUE, SUITE 330, SEATTLE, WA, 98101, US

(73) Assignee: Unicep Packaging, Inc., Sandpoint, ID (US)

(21) Appl. No.: 12/429,163

(22) Filed: Apr. 23, 2009

Related U.S. Application Data
(60) Provisional application No. 61/047,379, filed on Apr. 23, 2008.
(60) Provisional application No. 61/047,384, filed on Apr. 23, 2008.

(51) Int. Cl. B43M 11/06; B05C 17/00

(52) U.S. Cl. 401/183; 401/202

(57) ABSTRACT

Dispensing and applicator devices of the present invention provide delivery and application of a desired composition, generally in a single application volume and dosage, to a desired application location or surface. The devices generally comprise a combination of a flexible reservoir that is fillable or pre-filled with a treatment composition and an applicator component that accesses the treatment composition in the reservoir and delivers it to a desired tissue surface through a porous applicator. The reservoir and applicator components, and the treatment composition, may be sterilized and packaged in sterile format, or may be packaged to meet other “clean” or “sanitary” specifications short of sterility. Many uses are described, including applications of various compositions, including cosmetics, oral hygiene compositions, treatment agents and other substances to skin and tissue surfaces; industrial and household applications involving compositions such as cleaning agents, bonding agents, and the like to various types of surfaces, and food service applications involving compositions such as condiments, oils, and the like.

### REFERENCE TO PRIORITY APPLICATION

This application claims priority to U.S. Patent Application No. 61/047,379 filed Apr. 23, 2008, and to U.S. Patent Application No. 61/047,384 filed Apr. 23, 2008 which are incorporated herein by reference in their entireties.

### FIELD OF INVENTION

The present invention relates to dispensing and applicator devices providing convenient storage and dispensing of various types of compositions. The dispensing and applicator devices are generally designed for single use applications and comprise, in combination, a reservoir serving as a storage vessel for a liquid, semi-liquid, gel or paste composition and an applicator component that interfaces with the reservoir to access the composition and provides delivery and application of the composition to a desired application surface or location. In some embodiments, personal applicator devices are used to dispense and apply antibacterial and dentifrice compositions to the surfaces of teeth, gums and other tissues in and around the oral cavity. In some applications, dispensing devices are used to apply medicated, anti-bacterial, healing, cosmetic and other compositions to body surfaces. In alternative applications, dispensing devices are used for storage and application of agents for cleaning, bonding, repairing, lubricating, painting or surface coating various types of surfaces. In yet additional applications, devices are used for storing and dispensing ingestible compositions such as condiments, oils, flavorings, and the like.

### BACKGROUND OF THE INVENTION

Oral hygiene is one example of an essential aspect of personal healthcare and is important to maintain not only the health of the teeth and gums and oral tissues, but also to promote and maintain overall health. Regular brushing, flossing and use of oral washes are generally recommended to prevent build-up of residual materials, plaque and bacteria on tooth surfaces and in interproximal spaces, in gingival pockets, and on the gums and tongue. Many different devices and materials are available and are in wide usage, including toothbrushes, both power and manual, floss and floss applicators, dentifrices, mouth rinses and washes, oral irrigating devices, and various types of devices for cleaning interproximal spaces.

Many devices are directed to providing a stream or jet of liquid to assist in cleaning the oral cavity and tooth surfaces. An early dental hygiene liquid pressure device is described in U.S. Pat. No. 3,391,696 and includes a resilient bulb container, an outlet tube and a replaceable rubber or plastic applicator tip for delivering a continuous or pulsating jet stream from a resilient tip for cleaning teeth, gums, under bridgework, etc. Another oral hygiene device providing a stream of fluid to teeth and the spaces between teeth is described in U.S. Pat. No. 3,480,009. This device includes a container, a pump assembly and a hydro-pick for providing jet discharge of the solution at high velocity. Automated, water jet producing appliances for irrigating the oral cavity are also known and are in use.

A handheld device for treating gums by injecting a treating solution between the teeth to contact the gums is disclosed in U.S. Pat. No. 4,863,380. A squeezable reservoir expels fluid through ports in a hollow rubber tip, and a check valve prevents fluid in the mouth from entering the device. An oral irrigator syringe bulb having a rigid nozzle with a fluid outlet is described in U.S. Pat. No. 5,755,572. Another handheld device having a squeezable container or a hand operated pump for dispensing a viscous gel medicament into gingival openings is disclosed in GB patent publication 2 237 743 A. A handheld pressurized applicator for delivering medicaments to perio-pockets at the tooth-gum margin is described in U.S. Pat. No. 5,098,291. A fiber-coated dental infuser for applying a medicament under hydraulic pressure to infuse the medicament into exposed capillaries is described in U.S. Pat. No. 7,198,623. An interproximal squirt brush is described in U.S. Patent Publication 2007/0111158 A1.

Most of these devices and materials are best suited for home use where the user has privacy and access to a sink. Good oral healthcare requires regular, frequent cleaning however, particularly after meals and snacks, and conventional cleaning devices and systems that require a sink and privacy aren't well-suited for use away from home where a private bathroom is unavailable.

Many other types of dental applicators have been described. The following recitation is exemplary rather than exhaustive. A dental applicator in the form of a capsule having a discharge nozzle with fibers for distribution and spreading of the dental material is described in U.S. Pat. No. 6,059,570. An applicator assembly having a handle and an elongated shaft with a remote tip having a detachable cap is disclosed in U.S. Pat. No. 6,413,087. U.S. Pat. No. 6,669,475 discloses a device for cleaning interproximal dental surfaces, subgingival areas and periodontal pockets having a reservoir connected to a needle having a channel for flow of solution. This device also has an applicator with a cleaning section providing mechanical scrubbing and a distal applicator section having perforations allowing delivery of the solution. U.S. Pat. No. 7,232,310 discloses an interproximal squirt brush including a compressible solution container with a brush arm and brush portion inserted into the opening of the solution container. Solution is released to the brush member through a dispensing channel when the solution container is compressed. Flow through an applicator with resilient tip is disclosed in U.S. Pat. No. 6,334,774. A dental brush having a flexible fibrous tip with an internal cannula to allow medicament to flow through to the fibrous tip is described in U.S. Pat. No. 5,829,976. An interproximal brush having an hourglass shape that may include a resilient foam-like material forming the cleansing portion is disclosed in U.S. Pat. No. 5,851,116.

A dental container having a porous or foam flow through applicator for dispensing a low viscosity dental material is disclosed in U.S. Pat. No. 6,988,892. An interdental foam brush and treatment gel combination is disclosed in U.S. Pat. No. 5,283,924. The foam brush surface is tapered and can be impregnated with an agent dispersed in a gel medium.

Delivery of medicated, anti-bacterial, healing, cosmetic and other topically applied compositions can pose contamination issues and is generally messy. Compositions such as alcohol and antibacterial agents may be provided on pre-wet or self-saturating swabs or sponges in sealed packages that are generally designed for singe use application and are generally disposed of following use. Some compositions, such as various gels, ointments, healing agents, and the like, may be provided in single use packets that may be cut or torn to provide access to the reservoir containing the composition, and the composition may be expelled from the reservoir by squeezing the walls of the packet or pouch. Pre-filled swab dispensing devices are disclosed, for example, in U.S. Pat. No. 7,008,392, which describes a hemostatic wound cleansing swab.

Alternatively, antibacterial and other compositions are provided in a liquid form or gel form in multidose containers. These compositions may be removed from the multidose container and applied to the desired surface by contact, by pouring or spraying, or the like. The composition may alternatively be withdrawn from the container and spread on the desired surface using a finger or a swab or another intermediate. Use of compositions packaged in this way can be messy, unsanitary, and wasteful.

Delivery of single servings or fixed amounts of ingestible compositions such as condiments, oils, flavorings and the like, and other agents used for cleaning, bonding, repairing, lubricating, painting and surface coating various types of surfaces is also challenging. Delivery of a fixed amount or single “dose” of these types of compositions using a dispensing device that provides storage of the composition prior to use and provides dispensing of the composition at a desired application location without requiring the user to touch or distribute the composition at the application location is desirable in many situations and for many purposes.

Despite the number and variety of dispensing devices described in the patent literature and available in the marketplace, a need exists for portable storage and dispensing devices that facilitate effective storage, dispensing and application of liquid, gel and past materials under a variety of circumstances.

### SUMMARY OF THE INVENTION

Dispensing and applicator devices of the present invention provide storage and delivery of a desired composition, generally in a single application volume and/or dosage, to a desired application surface or site. The dispensing devices generally comprise a combination of a flexible reservoir that is fillable or pre-filled with a treatment composition and an applicator component that accesses the treatment composition in the reservoir and delivers it to a desired application site through a porous applicator. The reservoir and applicator components, and the treatment composition, may be sterilized and packaged in sterile format, or may be packaged to meet other “clean” or “sanitary” specifications short of sterility.

The flexible reservoir may be provided as a squeezable bulb or a pouch and may be pre-filled with a desired volume of a liquid, semi-liquid, gel or paste composition for delivery and application to a desired application location, such as a tissue surface or a work surface. The configuration of the applicator component and the porous applicator may be designed to provide delivery and application of the treatment composition to a wide variety of surfaces, and to generally small or large surface areas. In some applications, the applicator component facilitates delivery and application of a treatment composition to hard-to-access surfaces, such as tooth surfaces (including interproximal surfaces), gum surfaces and gingival pockets, tongue and lip surfaces, and other tissue surfaces in and near the oral cavity. In some applications, the applicator component facilitates delivery and application of a treatment composition to body surfaces, such as skin, skin lesions, wound sites, burn sites, and the like. In other applications, the applicator component facilitates delivery and application of treatment compositions such as bonding agents, cleaning agents, lubricating agents, coating agents, and the like, to the surfaces of various types of objects.

In one embodiment, the reservoir and applicator component may be provided as a unitary assembly, and the reservoir may be pre-filled with a desired volume (e.g., a single dosage unit) of a treatment composition. A detachable, liquid impermeable cover may be provided surrounding the porous applicator to prevent leakage of the composition through the porous applicator during storage and transport. This pre-filled, unitary personal dispensing assembly may be used simply by removing the impermeable applicator cap, positioning the porous applicator at a desired tissue site, and squeezing the flexible reservoir to deliver the composition through the applicator component and the porous applicator to the desired tissue site.

In another embodiment, a sealable reservoir having an access port may be pre-filled and sealed, and a separate applicator component having a stem insertable into the access port and a distal porous applicator may be provided. The user penetrates or removes the reservoir access port seal at the time of use to access the treatment composition stored in the reservoir and inserts the stem of an applicator component through the access port to access the treatment composition in the reservoir and provide a seal between the porous applicator and the reservoir. The user may then squeeze the reservoir to deliver the treatment composition through the applicator stem to the porous applicator, and from there to a desired body surface. The porous applicator may be used to contact the desired surface area to apply or distribute the treatment composition on the desired surface area. The applicator device of the present invention thus provides “touch-free” application of a treatment composition to a desired surface area.

Porous applicator tips having a variety of configurations may be provided for application of compositions to various surfaces. Generally tapered, conical porous tips may be provided, for example, for application of treatment compositions to irregular surfaces or surfaces that are non-uniform or that have cracks or cavities, or to small target surfaces. In some embodiments, such porous applicator tips are used for application of compositions in and around the oral cavity, such as teeth, gums, tongue and other tissues. Personal oral hygiene applicator devices of the present invention may be used, for example, to apply an anti-bacterial and/or medicated composition to reduce the bacterial population in mouth, to reduce the formation of biofilms (e.g., plaque), to improve or eliminate bad breath, to massage the gums, to improve periodontal health, and the like. In alternative embodiments, porous applicator tips may have a generally rounded or flattened profile for application of treatment compositions for applying a cleaning and/or anti-bacterial and/or medicated composition to skin surfaces and hard to access locations, such as ears, nasal cavities and the like, to reduce the bacterial population on skin surfaces or on lesions or wounds, to reduce the formation of biofilms, to inhibit bacterial and/or fungal growth on surfaces, and the like. Dispensing devices of the present invention are useful, for example, for treating skin lesions such as canker sores, herpetic lesions, acne, and other types of lesions.

The reservoirs and applicator components that, in combination, form applicator devices of the present invention, are preferably provided for single use application and are disposable, although multi-use embodiments are described and are contemplated by this invention. Single use reservoirs may be pre-filled with various liquid, semi-liquid, gel or paste compositions, then sealed, optionally sterilized, and provided to consumers in single or multiple unit packages. Access to the treatment composition in pre-filled, sealed reservoirs may be provided by means of a removable cap, by removing a tab, by puncturing a seal, or the like.

Applicator components generally comprise a structural portion, such as a stem, that is pre-mounted or mountable and sealable in an access port of the reservoir and provides a conduit for passage of the treatment composition from the reservoir to an applicator segment provided at a generally distal end of the applicator component. The treatment composition may be applied by delivery through the applicator segment of the structural applicator component, or it may be applied by delivery through a porous applicator associated with the applicator segment of the structural applicator component. In one embodiment, the structural applicator component is provided as an integral, unitary structure comprising a stem and an applicator segment with a porous applicator pre-mounted on the applicator segment. Alternatively, porous applicators may be provided and packaged separately from the structural applicator component and mounted on the applicator segment of the structural applicator component by a user just prior to application of the treatment composition. Porous applicators having different sizes, profiles and configurations may be provided for topical application of various treatment compositions to various types of tissue surfaces, object surfaces, hard and soft surfaces, and the like. Porous applicators having different pore sizes, pore densities and pore distributions, as well as various material properties, may also be provided for topical application of treatment compositions having various properties, e.g., viscosity, rheology, stability, particle suspensions, and the like.

Applicator systems of the present invention are exceptionally convenient and versatile. Reservoirs having different types, volumes and dosages of treatment compositions, suited for different applications, may be prefilled, sealed and packaged. Pre-filled reservoirs are generally intended for single use application and may be disposed of after use. Structural applicator components having various configurations designed for delivery of the treatment composition to various target sites may be provided. Porous applicators having various material properties, sizes and configurations suited for application of different types of treatment compositions (liquid, semi-liquid, gel, paste, and the like) to different application surfaces may likewise be packaged separately or in kits providing applicator combinations. The user may thus choose the treatment composition he or she needs, choose the structural applicator component and porous applicator best suited for applying the treatment composition to the desired application surface, and assemble the system just prior to use. Application of the composition to the desired application surface may be accomplished simply by inserting and sealing the applicator component in the reservoir and squeezing the reservoir, thereby discharging the composition through the porous applicator to the desired surface, without requiring the user to touch either the composition or the application surface. Following application of the composition, both the reservoir and the applicator may be discarded.

### BRIEF DESCRIPTION OF THE DRAWINGS

Exemplary and non-limiting embodiments of the components and devices of the present invention are described with reference to the following figures, in which:

FIG. 1A shows a schematic view of one embodiment of a sealed reservoir component of the present invention;

FIG. 1B shows a schematic view of the reservoir component illustrated in FIG. 1A in an unsealed condition with an applicator for insertion in the reservoir;

FIG. 1C shows a schematic view of the applicator assembled with a reservoir to provide personal applicator device of the present invention;

FIG. 2A shows a schematic view of another embodiment of a sealed reservoir component of the present invention;

FIG. 2B shows a schematic view of the reservoir component of FIG. 2A in an unsealed condition with an applicator for insertion into the reservoir;

FIG. 2C shows a schematic view of the applicator assembled with a reservoir to provide a personal applicator device of the present invention;

FIG. 3A shows a schematic view of another embodiment of a sealed reservoir component of the present invention;

FIG. 3B shows a schematic view of the reservoir component of FIG. 3A in an unsealed condition with an applicator for insertion into the reservoir;

FIG. 3C shows a schematic view of the applicator assembled with a reservoir to provide another personal applicator device of the present invention;

FIG. 3D shows a schematic side view of the personal applicator device illustrated in FIG. 3C;

FIG. 4A shows a schematic view of another embodiment of a sealed reservoir component of the present invention;

FIG. 4B shows a schematic side view of the reservoir component of FIG. 4A in an unsealed condition with an applicator for insertion into the reservoir;

FIG. 4C shows a schematic side view of the applicator components shown in FIG. 4B assembled to provide another personal applicator device of the present invention;

FIG. 4D shows a schematic side view of the applicator of FIG. 4C in an assembled configuration with a mating cap;

FIG. 4E shows a schematic side view of the cap mounted on the applicator of FIG. 4D;

FIG. 5A shows an enlarged schematic side view of a structural component of one embodiment of an applicator of the present invention;

FIG. 5B shows an enlarged view of the structural applicator component of FIG. 5A taken along line 5B-5B of FIG. 5A;

FIG. 6A shows an enlarged schematic side view of a structural component of an angled applicator similar to the applicator of FIG. 5A;

FIG. 6B shows an enlarged cross-sectional view of the structural applicator component taken along line 6B-6B of FIG. 6A;

FIG. 7A shows an enlarged schematic side view of a structural component of another embodiment of an applicator of the present invention;

FIG. 7B shows an enlarged view of the structural applicator component of FIG. 7A taken along line 7B-7B of FIG. 7A;

FIG. 8A shows an enlarged schematic side view of a structural component of an angled applicator having a structure similar to the applicator of FIG. 7A;

FIG. 8B shows an enlarged cross-sectional view of the structural applicator component of FIG. 8A along line 8B-8B of FIG. 8A;

FIGS. 9A-9D show enlarged schematic side views of applicators of the present invention having different configurations of applicator tips mounted on applicator structural components, wherein FIG. 9A shows a tapered, pointed distal end tip, FIG. 9B shows a tapered, blunt distal end tip, FIG. 9C shows tip having a larger diameter main section and a graduated distal section terminating in a blunt end, and FIG. 9D shows a tip having an even larger diameter main section and a graduated, rounded distal section;

FIGS. 10A-10D show enlarged schematic side views of applicators of the present invention having different configurations of angled applicator components mounted on applicator structural components, wherein FIG. 10A shows an angled, tapered, pointed distal end tip, FIG. 10B shows an angled, tapered, blunt distal end tip, FIG. 10C shows tip having an angled, larger diameter main section and a graduated distal section terminating in a tapered blunt end, and FIG. 10D shows a tip having an angled, even larger diameter main section and a graduated, rounded distal section;

FIG. 11A shows an enlarged schematic side view of another embodiment of a structural applicator component of the present invention;

FIG. 11B shows a schematic side view of the structural applicator component illustrated in FIG. 11A mounted in a reservoir of the present invention; and

FIG. 11C shows a schematic cross-sectional view of the applicator assembly taken through line 11C-11C shown in FIG. 11B.

### DETAILED DESCRIPTION OF THE INVENTION

While the present invention is described more fully and specifically hereinafter with reference to the accompanying drawings, in which specific components and embodiments are shown, it is to be understood that persons having skill in the art may modify the components and embodiments described herein without departing from the spirit of the invention. Accordingly, the embodiments that are illustrated and the detailed descriptions that follow are intended to be illustrative and exemplary of specific structures and embodiments, without limiting the broad scope of the invention.

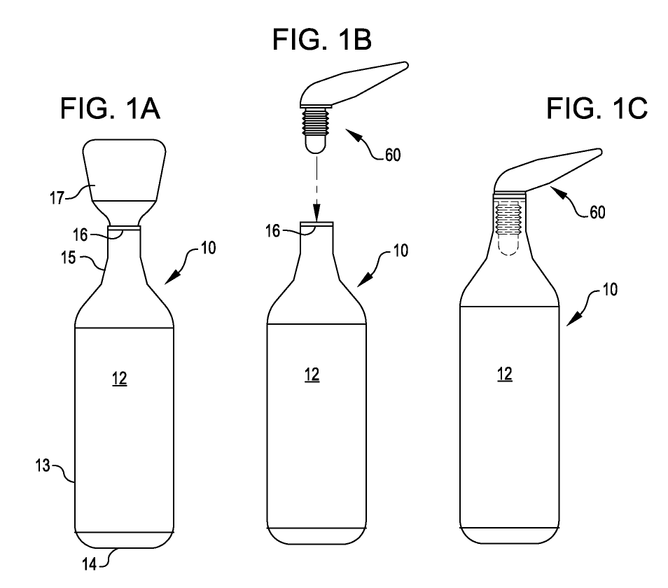

Applicator systems of the present invention generally comprise a reservoir, a structural applicator component and a porous applicator. FIGS. 1A-1C, 2A-2C, 3A-3D, 4A-4E and 11A-11C illustrate various combinations of reservoir components and structural applicator components having porous applicators, showing an assembly progression from a sealed reservoir to an opened, unsealed reservoir in a condition to receive a structural applicator component, to an applicator system comprising an applicator component inserted into and sealing in an access port of the reservoir. Various configurations of reservoir components, containing various types of treatment compositions, may be matched to various configurations of structural applicator components to provide applicator systems of the present invention, as illustrated.

The reservoir serves as a storage vessel for a composition to be dispensed through the applicator, is generally sealed or sealable, and has an access port providing access to the contents of the internal compartment. The reservoir may be provided as a packet or pouch, or as a rounded, bulbous structure providing an internal compartment having generally flexible and squeezable sidewalls to allow a user to apply pressure to discharge a liquid, semi-liquid, gel or paste treatment composition from the internal compartment through the access port. The reservoir is preferably provided in a sterile, pre-filled condition. The reservoir internal compartment may be provided in various sizes and capacities to dispense treatment composition volumes of from about 0.2 ml to about 25 ml or more, more generally from about 1 ml to about 15 ml.

The reservoir access port is generally sealed prior to use to maintain the sterility and integrity of the contents. The reservoir port may be sealed by means of a foil or plastic cover bonded to the access port or an associated structure, or by another sealing mechanism that may be punctured or otherwise opened by a user to provide access to the internal compartment. The reservoir access port may alternatively be sealed by means of a detachable cap (e.g., screw cap, press-fit cap, etc.). In yet another embodiment, the reservoir port is sealed and access may be provided by means of a removable tab or the like, or any combination of these sealing mechanisms may be used.

Several exemplary embodiments of reservoir components of the present invention are illustrated in FIGS. 1A, 2A, 3A and 4A. Reservoir 10 illustrated in FIG. 1A comprises a container 12 having a generally cylindrical configuration with a continuous sidewall 13 and a generally flattened bottom wall 14. At one end, tapered side wall 15 terminates in an access port 16 which is sealed by connection to tab 17 in an unopened condition. Tab 17, in the embodiment illustrated in FIG. 1A, is removable to expose access port 16 and the contents of container 12 by breaking along a pre-formed weakened area. Access port 16 and the portion of tab 17 sealed to the access port may be generally circular or oval or any other configuration. Tab 17 may also have a flattened portion to facilitate grasping and removal of the tab from the reservoir.

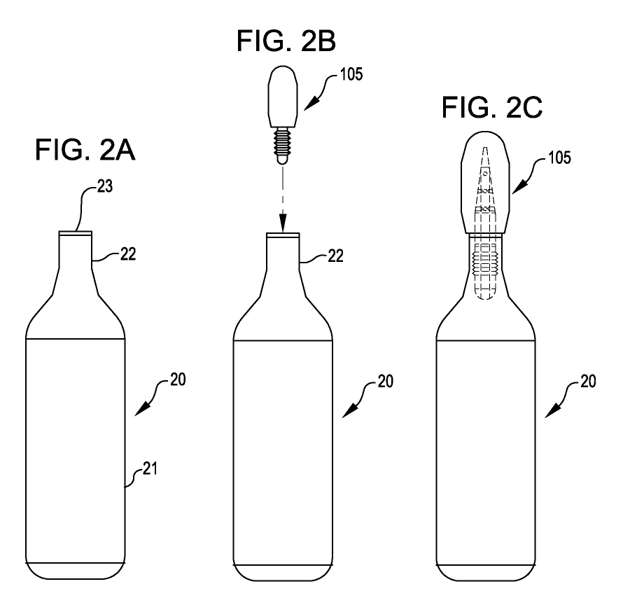

FIG. 2A illustrates an embodiment in which reservoir 20 is provided as generally cylindrical chamber having an internal compartment for storage of a treatment composition. In this embodiment, side wall 21 terminates at one end in an access port 22 which is sealed by means of a cover 23, which may be a foil or film layer bonded to the access port or an associated structure. The foil or film cover is preferably removable or puncturable to provide access to the treatment composition stored in the internal compartment. Although reservoirs 12 and 20, shown in FIGS. 1A and 2A are illustrated as being generally cylindrical, it will be appreciated that the reservoir may be provided in many different configurations, including generally round, generally oval, bulbous, or the like.

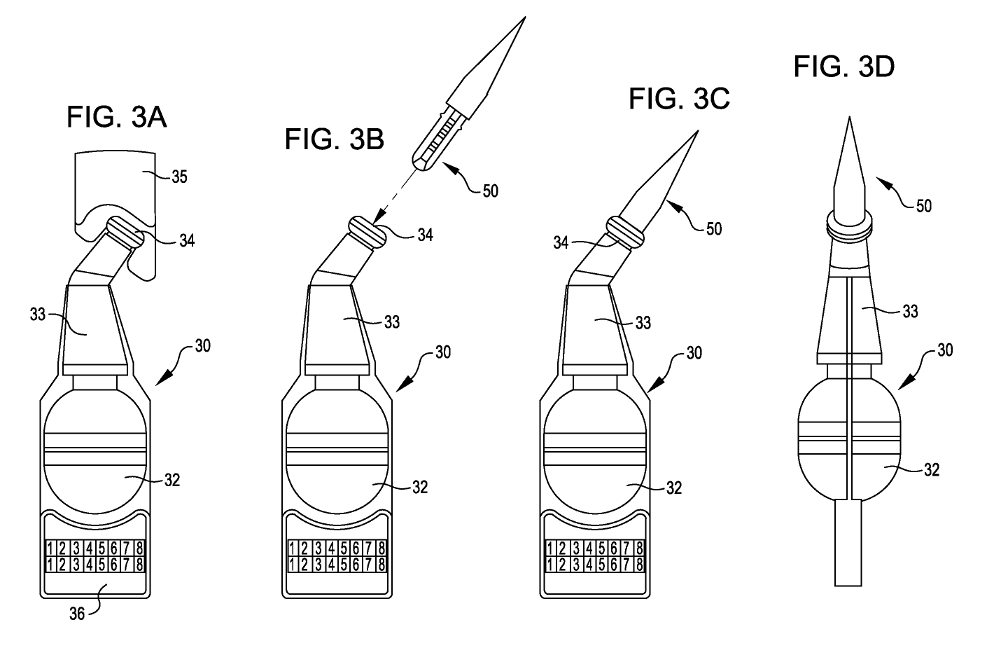

FIGS. 3A-3D illustrate yet another embodiment of a reservoir 30 of the present invention having a generally rounded portion 32 forming an internal compartment. The internal compartment of rounded portion 32 is in fluid communication with an outlet channel 33 that accesses outlet port 34. Rounded portion 32 preferably has a larger dimension providing greater volume than outlet channel 33. Outlet port 34 may be sealed by attachment to tab 35, which may be detachable from access port 34 and mount an applicator unit. Other types of closure devices may alternatively be provided, as described above. Reservoir 30 is generally formed as a unitary structure, with rounded portion 32 provided as a continuous structure with outlet channel 33 and outlet port 34, although in some embodiments, these components may be provided separately and assembled prior to use.

Outlet channel 33 may be substantially straight, or it may be curved or angled, as shown in FIGS. 3A-3D. Angled outlet channels allow positioning of an applicator component at an angle to the reservoir chamber, which may facilitate application of the treatment composition to various application locations, and may improve visibility of the application site during application. The outlet channel angle is described as the interior angle formed by the longitudinal axis of the angled channel portions with respect to a longitudinal and/or central axis of the reservoir. Outlet channel angles of greater than about 90° and less than about 180° are suitable; outlet channel angles of greater than about 100° and less than about 160° are especially suitable for many applications; outlet channel angles of greater than about 110° and less than about 130° are preferred for many applications; and outlet channel angles of from about 115° to about 125° are preferred for many applications.

In the embodiment illustrated in FIGS. 3A-3D, reservoir 30 additionally comprises a flattened area 36 having a generally rigid or semi-rigid structure located in proximity to the rounded portion forming the internal compartment and generally opposite the outlet channel for grasping by a user. The flattened area may also be used for marking with information such as the contents of the internal compartment, lot number, expiration date, volume, dosage, identification information pre-printed or provided by the user, etc.

Although the reservoirs have been illustrated as being generally cylindrical or rounded, it will be appreciated that reservoirs having a variety of configurations, sizes, and orientations may be provided. The reservoirs and other components may be transparent or translucent or opaque and may be ornamented or provided with labeling and/or decoration. Reservoirs (12, 20, 30) are preferably fabricated from a material that is flexible and squeezable using relatively modest forces that can be easily exerted by a user. Materials such as relatively thin-walled plastics and thermoplastic materials, such as various types of polyethylene (e.g. LDPE, MDPE or HDPE) and polypropylene (PPE) are suitable. Reservoirs can be fabricated by injection molding, traditional blow molding, insert blow molding, co-injection molding (two shot molding), insert injection molding and fill-faced processes, and may be formed in one piece or in multiple pieces that are later joined and bonded. Reservoirs of the present invention may, for example, be fabricated from single parison extrusions of thermoplastic materials, or from a coextrusion parison to provide for better barrier, decorative or functional characteristics. Reservoirs providing different reservoir volumes, constructed from different materials and containing different compositions are generally usable with common applicators described herein having a stem that mates with the reservoir access port.

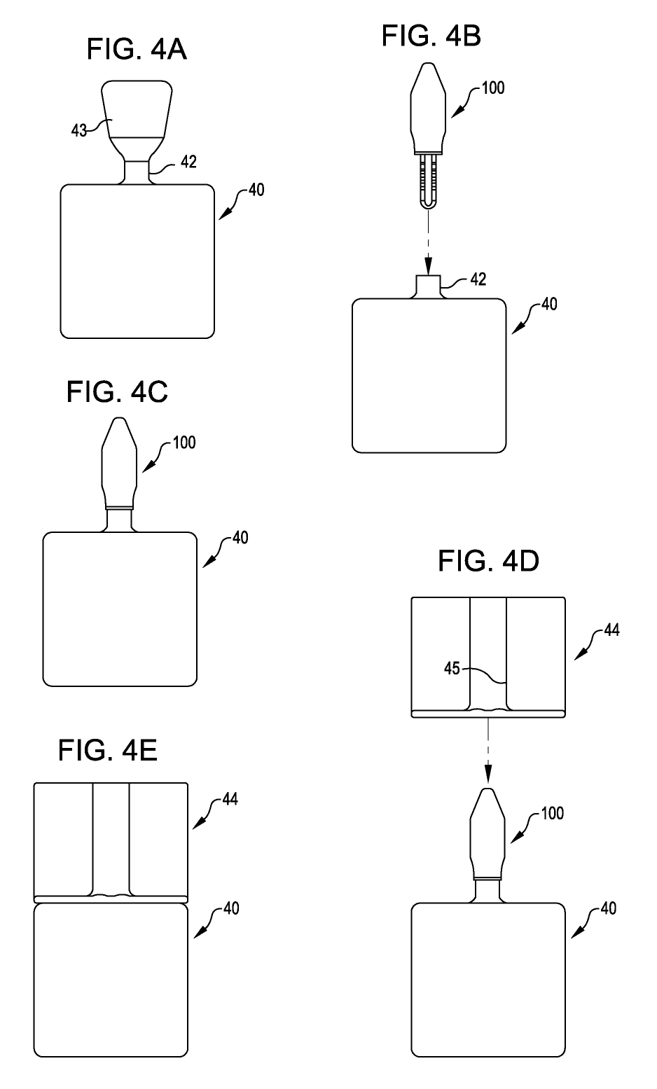

Yet another type of reservoir 40 is illustrated in FIGS. 4A-4E. Reservoir 40 is a sealed packet that may be provided in a variety of configurations, with a generally rectangular configuration illustrated. Other shapes and configurations of sealed packets or pouches may be provided, as is well known in the art. Walls of reservoir 40 are flexible and form a sealed or sealable internal compartment for storing a desired volume of a liquid, semi-liquid, gel or paste composition. The sidewalls of reservoir 40 are sealed along their perimeters, but for an access port 42, which may be sealed to the reservoir side walls in its vicinity. Access port 42 is sealed or sealable, such as by tab 43 or by a removable or puncturable seal and, when removed or punctured or uncovered, provides an opening for mounting and sealing an applicator component. The sidewalls of reservoir 40 may comprise a film or web-based material providing a form-fill-seal pouch-type package. Exemplary films for constructing this pouch include PET with an EVOH liner as a barrier, foil laminated films, and the like. Many different types of materials that are known in the art are suitable for constructing this type of flexible, fillable pouch having a fitment for inserting an applicator component. In pouch reservoirs and other types of packets or pouches, the applicator (stem and tip) component may be inserted and mounted in the reservoir prior to or following filling and prior to distribution and use, or the stem and tip component may be inserted by the user.

Applicator components of the present invention generally comprise a structural shaft having stem that is insertable into the access port of the reservoir in combination with a distal applicator segment that may be associated with a porous tip or applicator. The stem of the shaft is generally constructed from a material that is slightly deformable but not substantially bendable under pressures associated with mounting in a reservoir and contacting an application surface during dispensing of the composition. The stem may be constructed, for example, from thermoset plastics such as polypropylene (PPE) and other materials such as polyacetals (e.g., Delrin), polycarbonates, nylons, polyesters, and the like.

The outer surface of the applicator stem is preferably configured and sized to generally match or be slightly larger than the inner surface of the reservoir access port, so that the applicator stem may be interference fit in a reservoir opening to seal the opening and access the treatment composition. The material and construction of the stem is such that the stem surfaces are locally and slightly deformable to mount and seal the applicator stem in the reservoir access port. Lubricious materials may be coated or otherwise provided on the surface of the stem where it is inserted into the access port to facilitate insertion and seating of the stem in the reservoir access port.

In applications in which the shaft is preinserted in the reservoir, such as in the dispensing device illustrated in FIG. 4D comprising a combination of reservoir 40 and an applicator shaft with porous applicator tip 100, a thermoplastic bond may be provided between the shaft and reservoir, or an adhesive, such as a UV adhesive, may be used to bond the shaft to the reservoir. FIGS. 4D and 4E also illustrate a cap 44 having an internal passageway 45 positioned and configured to accommodate the distal end of the applicator shaft and porous applicator tip. Pre-assembled dispensing devices may be assembled and packaged in a pre-filled condition with a removable cap substantially sealing the applicator to prevent loss of the pre-filled composition through the applicator. These pre-assembled and capped devices may be used simply by removing the cap and squeezing the reservoir to expel the stored composition. Multi-use dispensing devices may also be provided with a mating cap to substantially seal and protect the applicator and prevent loss of the pre-filled composition during periods of storage.

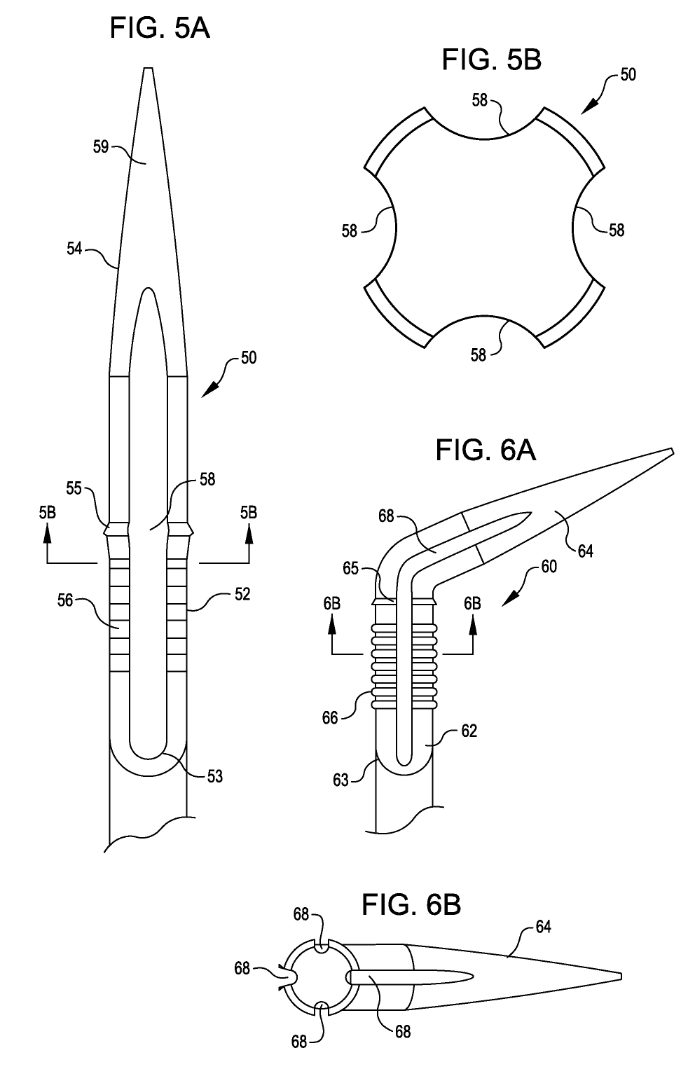

Several embodiments of applicator shafts are illustrated in FIGS. 5A-11A. FIGS. 5A and 5B illustrate an applicator shaft 50 having a generally cylindrical stem 52 and a tapered distal segment 54. An insertion portion of stem 52 comprises an end portion 53 sized and configured for passage through an access port of a reservoir and an enlarged collar 55 sized larger than the access port to provide a stop during insertion of the stem through the access port and facilitate seating of the stem in the port and sealing of the reservoir following insertion of the stem. In the embodiment illustrated in FIG. 5A, applicator stem 52 has circumferential ridges 56 on its outer surface oriented generally transverse to the longitudinal axis of the stem to facilitate an interference fit with the inner wall of the reservoir access port. In one embodiment, the circumferential ridges 56 aren't strictly horizontal but, rather, droop in an upward direction to facilitate sealing between the stem and the inner wall of the access port. The applicator stem may thus be inserted through a reservoir access port and positioned with the end portion 53 immersed in the contents of the internal compartment, with the collar 55 and remaining portion of the stem sealing the internal compartment of the reservoir. The applicator stem may alternatively be provided with any type of mechanical structure that, in combination with the structure of the inner wall of the reservoir access port, provides a liquid seal, such as a screw mount, bayonet mount, or the like.

Applicator shafts have structures that provide a route for delivery of the treatment composition from the reservoir through or along the shaft to an applicator segment of the shaft, and/or a porous applicator tip associated with the applicator segment of the applicator shaft. In the embodiment illustrated in FIG. 5A, applicator shaft 50 has at least one channel 58 provided on its exterior surface. As shown in FIG. 5B, applicator shaft 50 has four channels 58 spaced equidistantly and radially symmetrically around its perimeter. Channels 58 are oriented generally in alignment with the longitudinal axis of the applicator component. More or fewer channels may be provided in alternative embodiments, and the channels may be oriented at an angle to or in other relationships to the longitudinal axis of the applicator component. Channel(s) 58 extend from a portion of applicator shaft 50 that is positioned in the internal compartment after mounting on a reservoir access port to a portion of the applicator shaft having a delivery mechanism, such as a porous tip to deliver the treatment composition from the reservoir to the desired application site upon application of pressure to the reservoir.

The distal segment 54 of applicator shaft 50 is generally continuous with stem 52 and has continuous channel(s) 58 for delivery of the treatment composition stored in the reservoir to an applicator tip. The distal end of segment 54 may be tapered, as illustrated in FIG. 5A, and channel(s) 58 may extend to and terminate in the tapered section 59.

FIGS. 6A and 6B illustrate an applicator shaft 60 having a structure similar to that of shaft 50 illustrated in FIGS. 5A and 5B, but having an angled configuration. Applicator shaft 60 has a generally cylindrical stem 62 and a tapered distal segment 64. An insertion portion of stem 62 comprises an end portion 63 sized and configured for passage through an access port of a reservoir and an enlarged collar 65 sized larger than the access port to provide a stop during insertion of the stem through the access port and to facilitate seating of the stem in the port and sealing of the reservoir following insertion of the stem. In the embodiment illustrated in FIG. 6A, applicator stem 62 has circumferential ridges 66 on its outer surface oriented generally transverse to the longitudinal axis of the stem to facilitate an interference fit with the inner wall of the reservoir access port.

Applicator shaft 60 has at least one channel 68 provided on its exterior surface. As shown in FIG. 6B, applicator shaft 60 has four channels 68 spaced equidistantly and radially around its perimeter and oriented generally with the longitudinal axis of the applicator component. Channel(s) 68 extend from a portion of applicator shaft 60 that is positioned in the internal compartment after mounting on a reservoir to a portion of the applicator shaft associated with a porous tip to deliver the stored composition from the reservoir to the porous applicator tip upon application of pressure to the reservoir. The distal segment 64 of applicator shaft 60 is generally continuous with stem 62 and has continuous channel(s) 68 for delivery of the composition stored in the reservoir to an applicator tip. The distal end of segment 64 may be tapered, as illustrated in FIG. 6A, and channel(s) 68 may extend to and terminate in the tapered section.

The applicator shaft may be substantially straight, as illustrated in FIGS. 5A and 5B, or it may be curved or angled, as shown in FIGS. 6A and 6B. Angled applicator shafts allow positioning of an applicator component at an angle to the reservoir chamber, which may facilitate application of the composition to various body locations, and may facilitate visibility of the tissue site during application. The shaft angle is specified as the angle formed by the longitudinal axis of the angled portions. Angles of greater than about 90° and less than about 180° are suitable; angles of greater than about 100° and less than about 160° are especially suitable for many applications; preferred angles for many applications are from about 110° to about 150°; preferred angles for many applications are from about 115° to about 125°.

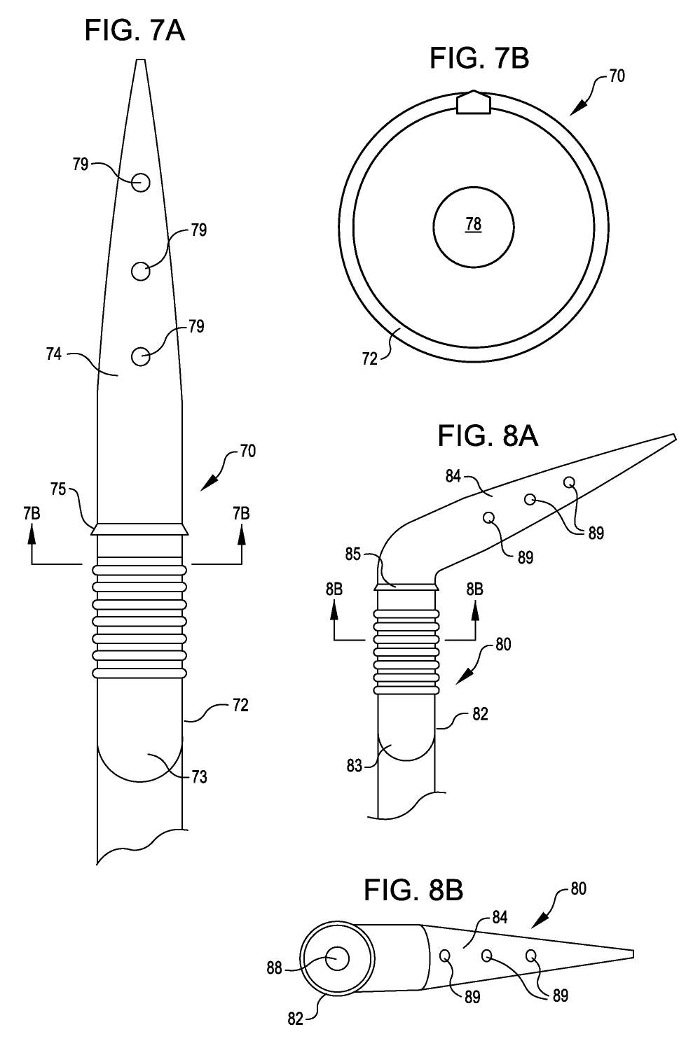

FIGS. 7A, 7B, 8A, 8B and 1A illustrate yet additional embodiments of applicator shafts of the present invention. Applicator shafts 70 and 80, respectively, illustrated in FIGS. 7A and 8A, have generally cylindrical stems 72, 82 and tapered distal segments 74, 84, respectively. An insertion portion of stems 72, 82 comprises end portions 73, 83 sized and configured for passage through an access port of a reservoir and enlarged collars 75, 85 sized larger than the access port to provide a stop during insertion of the stem through the access port and to facilitate seating of the stem in the port and sealing of the reservoir following insertion of the stem. Applicator stems 72, 82 have circumferential ridges on their outer surfaces to facilitate an interference fit with the inner wall of the reservoir access port.

Applicator shafts 70, 80 have at least one internal channel providing a conduit for delivery of a composition from the reservoir to a porous tip mounted on the applicator shaft. In the embodiments illustrated in FIGS. 7A, B and 8A, B, internal channels 78, 88 are formed in stem sections 72, 82 and extend to distal segments 74, 84 to provide a substantially continuous channel for delivery of the treatment composition stored in the reservoir. Outlet ports 79, 89 are provided in distal segments 74, 84 and communicate with the internal channels 78, 88 to provide delivery of liquid, semi-liquid, gel and paste compositions. Outlet ports 79, 89 may be provided in the side walls of distal segments 74, 84, as illustrated, and may additionally or alternatively be provided at a distal tip of the distal segments. A plurality of outlet ports 79, 89 may be provided and arranged along the length of the distal segments, and may be provided in a radially symmetrical arrangement.

Outlet ports 79, 89 are preferably arranged to provide a generally even discharge of treatment composition from the distal segment 74, 84 of applicator shafts 70, 80. FIGS. 7A and 7B illustrate applicator shafts having a generally linear configuration in which both the stem and distal segments are arranged on substantially the same longitudinal axis, while FIGS. 8A and 8B illustrate applicator shafts having a generally angled configuration in which the longitudinal axis of the distal segment is angled with respect to the longitudinal axis of the stem. Suitable angles have been described.

FIG. 11A illustrates yet another embodiment of an applicator shaft 110 of the present invention having an enlarged stem section 112 and a tapered distal segment 114. An insertion portion of stem 112 comprises end portion 113 sized and configured for passage through the reservoir access port, a tapered portion 115 having an enlarged diameter closer to end portion 113 and a smaller diameter closer to an enlarged collar 116 serving as an insert stop during insertion of the stem through the reservoir access port to facilitate seating of the stem in the port and sealing of the reservoir following insertion of the stem. Applicator shaft 110 has at least one internal channel providing a conduit for delivery of a composition from the reservoir to outlet ports 119 provided in the distal segment 113 of the applicator shaft. The enlarged stem section of applicator shaft 110 is sized and configured to interact closely with an inner surface of a mating reservoir access port. This feature may be provided in combination with any of the other applicator stems disclosed herein.

For some applications, applicator systems of the present invention may comprise a reservoir in combination with an applicator component, as described above, for delivery of a composition through grooves or outlet ports, or other outlets, provided in the applicator component. For many applications, a porous applicator tip is mountable or mounted on at least a portion of the distal segment of the applicator stem component to facilitate distribution of the treatment composition stored in the reservoir on a desired treatment surface. The porous applicator may comprise a material that facilitates distribution or spreading of a composition across surfaces.

Porous materials such as foam materials, including open cell polyurethane foam materials that absorb and allow passage of liquids, semi-liquids, gels, pastes and viscous fluids are suitable. Materials such as polyester-polyurethane reticulated foam materials are exemplary suitable materials. The range of suitable pore sizes varies with the material being distributed through the porous material and may range from about 10 microns to 1 mm; suitable pore sizes for certain materials may range from about 40 microns to about 300 microns; and suitable pore sizes for other materials may range from about 50 microns to about 150 microns. Suitable porous materials may have substantially uniform pore sizes throughout the foam applicator tip, or the pore size may vary, with different pore size distributions provided in different areas of the foam applicator tip. Suitable porous materials may have a wide variety of densities, depending on the pore size and distribution, and on the material being distributed through the porous tip. Porous material densities of from about 0.4 to about 5 lb/ft³ are suitable for some applications; porous material densities of from about 1.0 to about 3.5 lb/ft³ are suitable for some applications; and porous material densities of from about 1.5 to about 2.5 lb/ft³ are suitable for some applications. The tensile strength of the porous material may likewise vary substantially.

For many applications, the porous applicator tip is fabricated from a uniform monolayer of foam material, but alternative embodiments may encompass porous applicator tips having multiple foam sections or layers, with different sections of layers having different structural and/or functional properties. The foam applicator tip is generally bonded to the distal segment of the stem component using a bonding agent such as a glue, or by heat staking. Various materials, such as abrasives, coatings, detergents, dyes, antibiotics, surfactants and other materials may be incorporated in or on the porous applicator tip. Woven and non-woven textile materials may also be used. Auxiliary components such as small bristles or fibers may be provided in association with the porous applicator tip to facilitate generally uniform app'n of material. “Microstructured” surfaces may also be used on all or a portion of the porous applicator tips.

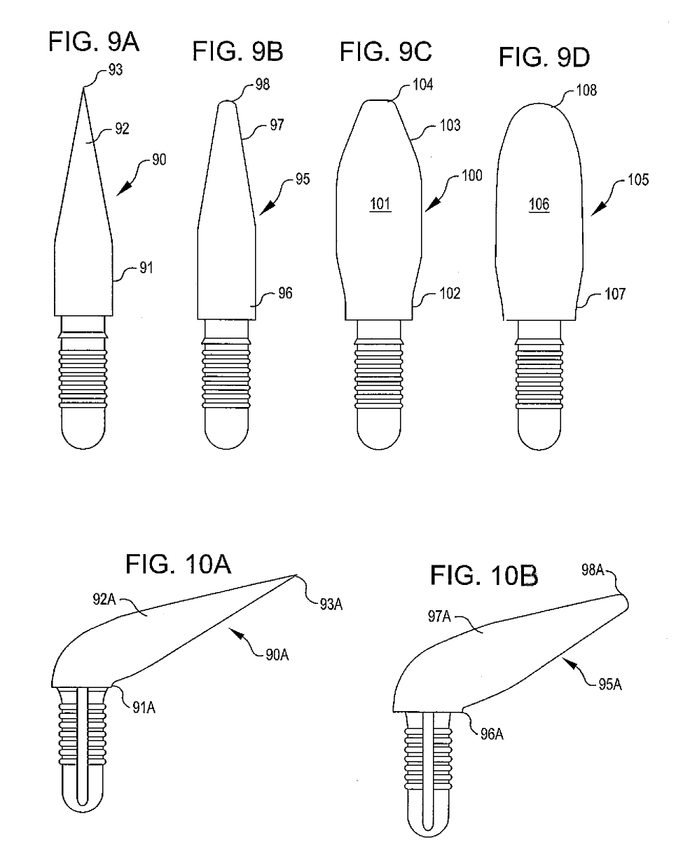

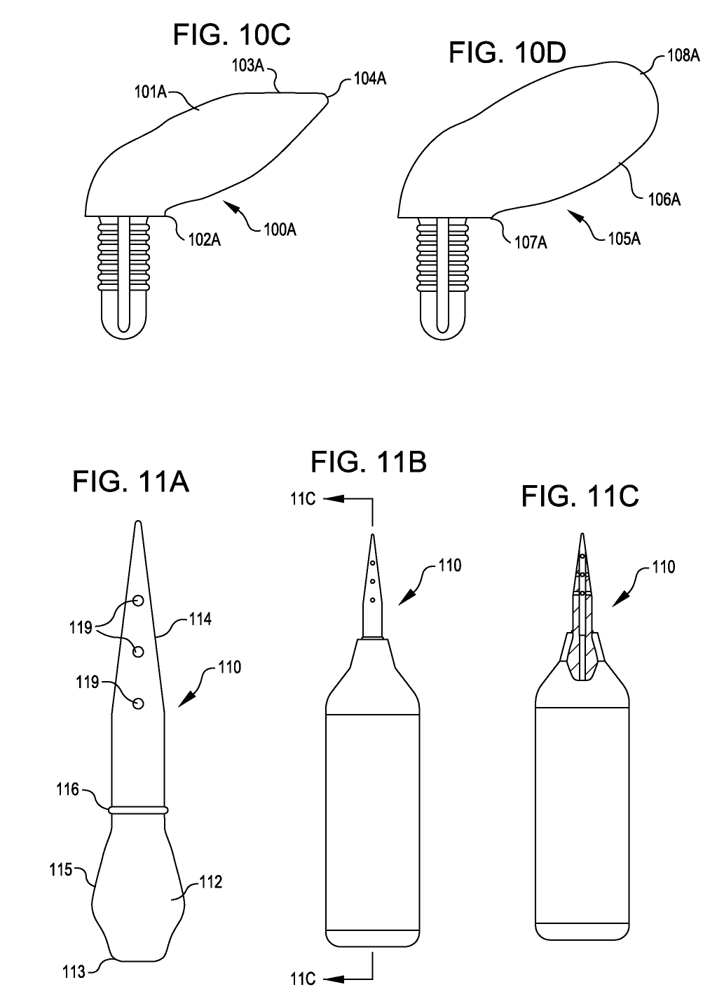

Different configurations of porous applicator tips may be provided for application of different treatment compositions to different tissue sites and for use by different user populations. Several different configurations of porous applicator tips are illustrated for use with generally straight stem components in FIGS. 9A-9D and with generally angled stem components in FIGS. 10A-10D. Porous applicator tips 90 and 90A, illustrated in FIGS. 9A and 10A, respectively, comprise a generally cylindrical proximal segment 91, 91A, respectively and a tapered, generally conical distal segment 92, 92A, respectively, terminating in a generally pointed tip 93, 93A, respectively. The proportions of the proximal segment to the distal segment may differ depending on the configuration of the porous tip applicator, as shown. Porous applicator tips 95 and 95A, illustrated in FIGS. 9B and 10B, comprise a generally cylindrical proximal segment 96, 96A and a tapered, generally conical distal segment 97, 97A terminating in a blunt tip 98, 98A. Porous applicator tips 100 and 100A, illustrated in FIGS. 9C and 10C, comprise a generally larger diameter main section 101, 101A having a necked down proximal section 102, 102A and a graduated distal section 103, 103A terminating in a blunt end 104, 104A. Porous applicator tips 105 and 105A, illustrated in FIGS. 9D and 10D, comprise an even larger diameter main section 106, 106A having a necked down proximal section 107, 107A and a graduated, rounded distal section 108, 108A. The proximal sections of porous applicator tips are generally arranged and configured so that, when the applicator component is mounted in a reservoir, the proximal section of the porous applicator tip contacts or is in close proximity to the reservoir access port and enlarged collar.

Treatment compositions suitable for use with personal oral hygiene applicator devices of the present invention may be in a liquid, semi-liquid, gel, lotion, suspension or paste carrier having a viscosity suitable for passing through the stem component channel(s) or delivery ports and porous applicator tips. The composition may comprise a carrier fluid such as water (distilled, de-ionized, purified, etc.), glycerin, poloxamer(s), surfactant(s), viscosity or gelling agent(s), flavoring agent(s), coloring agent(s), preservatives such as parabens, citric acid or benzoates, and one or more active ingredients.

In one embodiment, active ingredient(s) may include treatment compositions for application to hard or soft tissue in or in proximity to the oral cavity, including one or more of the following: dental treatment agents such as fluoride (monograph or prescription strength); chlorhexidine; cleaning or dental whitening agents, canker sore or herpes treatments, medicated treatments, herbal or natural remedies; ethanol and other alcohol-containing compositions; anti-bacterial compositions (e.g., triclosan); EDTA; topical anesthetic compositions (e.g. Benzocaine); antibiotic compositions (e.g., tetracycline); antifungal compositions; anti-viral compositions (e.g. Acyclovir, Valtrex); healing agents (e.g. aloe, growth factors, etc.); medicated topical healing agents, periodontal treatments; pain medications; and other types of oral hygiene treatment agents.

In another embodiment, active ingredient(s) may include one or more of the following: an herbal or natural remedy; a sanitizing or an antibacterial composition such as ethanol; triclosan; EDTA; Retinol A; a topical anesthetic (e.g. Benzocaine); an antipuritc or antibiotic (e.g., tetracycline); an antifungal; an anti-viral agent (e.g. Acyclovir, Valtrex); an anti-fungal agent; a healing agent (e.g. aloe, growth factors, etc.); a medicated composition for topical application; a topical healing agent (e.g. burn treatment such as nystatin, acne treatment, wart treatment); a cleaning agent for cleaning the skin, ears, nasal passages, or for removing nail polish or other residues; agents for treating insect bites and other injuries; and the like. The composition may comprise a fragrance or a cosmetic composition, such as perfume, lotion, cologne, coloring agents for hair, skin or the like, skin toners and astringents. The composition may alternatively comprise a composition intended for oral ingestion and carried in a liquid, semi-liquid, gel carrier or the like, including vitamins, supplements, various types of remedies; or food compositions such as condiments, oils, and the like. In other applications, the composition may comprise a cleaning agent, bonding agent, coloring agent such as a paint or stain, a repair composition, or the like for delivery and application to a surface of an object. Dispensing devices of the present invention may be used in human and animal health and cosmetic applications, as well as in personal household and industrial applications.

Reservoir and applicator components may be packaged separately and assembled prior to use, or may be packaged pre-assembled with a seal covering the applicator. Single units may be packaged unassembled with an applicator component (with pre-attached porous applicator tip) and reservoir packaged in a single sealed pouch; multiple applicator components and reservoirs may be pre-packed, together or separately, in multi-application packets. Applicator components may be mounted in and access reservoirs having a variety of configurations and volumes, and containing a variety of materials, providing a modular approach to personal oral hygiene applicator devices and treatment. Both the reservoir and the applicator component are generally provided as single-use devices that may be disposed of after single use. The reservoir and applicator components may alternatively be provided as re-usable and/or re-fillable components.

In use, a sealed reservoir having a composition stored in a sealed internal compartment is grasped by user and the internal compartment is accessed by puncturing a seal or removing a detachable tab or cover to expose the reservoir opening. The stem of the shaft component is mounted in opening and contacts the material. This sequence is illustrated with reference to different types of reservoirs and applicator components of the present invention in FIGS. 1A-1C, 2A-2C, 3A-3C, 4A-4C and 11A-11C.

Following assembly of the applicator system of the present invention, the user positions the porous applicator in proximity to the desired application surface and squeezes the reservoir as the porous applicator is moved across the desired application surfaces to apply the composition stored in the reservoir to the surface(s). In oral hygiene applications, the porous applicator tip is moved across tooth surfaces and in interproximal spaces as the reservoir is squeezed to apply dental composition to tooth surfaces and spaces.

We claim:

1. An applicator device comprising a reservoir having flexible walls serving as a storage vessel for a liquid, semi-liquid, gel or paste composition and an applicator shaft component comprising a stem and a porous tip, the stem being inserted or insertable in the reservoir to access the composition, and the porous tip providing distribution of the composition to a desired application location.

2. The applicator device of claim 1, wherein the reservoir is pre-filled with desired composition.

3. The applicator device of claim 1, wherein the reservoir and applicator shaft components are provided as a unitary assembly, with reservoir pre-filled with desired volume of a composition.

4. The applicator device of claim 3, additionally comprising a detachable, liquid impermeable cover surrounding the porous applicator to prevent leakage of the composition through the porous applicator during storage and transport.

5. The applicator device of claim 1, wherein the reservoir is prefilled with the composition and sealed at an access port and the stem of the applicator shaft component, when inserted through the access port, forms a seal between the applicator shaft component and the reservoir.

6. The applicator device of claim 1, wherein the reservoir has flexible and squeezable side walls forming a rounded internal compartment containing the liquid, semi-liquid, gel or paste composition.

7. The applicator device of claim 6, wherein the internal reservoir component is capable of storing a volume of from about 0.2 ml to about 25 ml of the composition.

8. The applicator device of claim 1, wherein the reservoir is prefilled and is sealed at an access port by connection to a detachable tab that is removable to expose the access port.

9. The applicator device of claim 1, wherein the reservoir has an internal compartment in fluid communication with an outlet channel terminating in an access port.

10. The applicator device of claim 9, wherein the outlet channel is angled with respect to a longitudinal or central axis of the reservoir.

11. The applicator device of claim 10, wherein the internal angle of the outlet channel with respect to a longitudinal or central axis of the reservoir is greater than 100° and less than 160°.

12. The applicator device of claim 1, wherein the porous tip has a generally tapered, conical configuration.

13. The applicator device of claim 1, wherein the porous tip has a generally rounded, flattened profile.

14. The applicator device of claim 1, additionally comprising a flattened area in proximity to the flexible walls of the reservoir, the flattened area having a rigid or semi-rigid structure.

15. The applicator device of claim 1, wherein the applicator stem has a generally cylindrical insertion portion sized to fit in a reservoir access port, and the cylindrical insertion portion has a plurality of circumferential ridges oriented generally transverse to a longitudinal axis of the stem.

16. The applicator device of claim 1, wherein the applicator shaft component has at least one channel provided in an exterior surface, the channel accessing the composition stored in the reservoir when the applicator shaft component is mounted in the reservoir.

17. The applicator device of claim 1, wherein the applicator shaft component has at least one internal channel providing a conduit for delivery of the composition from the reservoir to the porous tip when the applicator shaft component is mounted in the reservoir.

18. The applicator device of claim 1, wherein the applicator shaft is angled with respect to a longitudinal or central axis of the reservoir, forming an internal angle of greater than 100° and less than 160°.

19. The applicator device of claim 1, wherein the reservoir is prefilled with a composition selected from among the following: antibacterial and dentifrice compositions.

20. The applicator device of claim 1, wherein the reservoir is pre-filled with a composition selected from among the following: medicated, healing, cleaning, herbal remedy, vitamin, fragrance and cosmetic compositions.

21. The applicator device of claim 1, wherein the reservoir is pre-filled with a composition selected from among the following: cleaning, bonding, repairing, lubricating, painting or surface coating compositions.

22. The applicator device of claim 1, wherein the reservoir is pre-filled with an orally ingestible composition.
